(19) United States
(12) Patent Application Publication
(10) Pub. No.: US 2025/0280989 A1
(43) Pub. Date: Sep. 11, 2025

(54) LIQUID DISPENSING CONTAINER WITH AN INTEGRATED TOROID BASE FOR USE IN A BEVERAGE POD OR CAPSULE USED IN A BREWING MACHINE

(71) Applicants: Nickolas CHRISTENSEN, San Jose, CA (US); James HAO, San Jose (CA)

(72) Inventors: Nickolas CHRISTENSEN, San Jose, CA (US); James HAO, San Jose (CA)

(21) Appl. No.: 18/596,493

(22) Filed: Mar. 5, 2024

(51) Int. Cl. A47J 31/36; A47J 31/06

(52) U.S. Cl. CPC A47J 31/3628; A47J 31/0663; A47J 31/0668

(57) ABSTRACT

The present invention pertains to a beverage pod that has at least two separate compartments inside. One compartment holds a liquid beverage ingredient without leaking into the other compartment. It has a toroid portion to ensure that it can be pierced by a needle fixed in place as part of the brewing machine. The liquid (e.g., irish cream), is kept apart from the dry ingredient (e.g., ground coffee) in the other compartment until a brewing process is initiated. During the brewing process, these ingredients can be combined with hot or cold water to produce a uniquely flavored beverage for human consumption.

### BACKGROUND OF THE INVENTION

### Field of the Invention

Embodiments of the present invention generally relate to a disposable single serve beverage pod that has a solid, non-permeable, watertight container with a toroid base integrated therein.

### Background of the Present Invention

Coffee is one of the most popular beverages globally, and the market is expanding well into the future. Coffee is delicious, both in taste and smell. It comes in numerous varieties, such as expresso, cappuccino, latte, thereby allowing individuals to tailor their coffee experiences to their preferences. In addition, there are numerous coffee bean varieties, roasting techniques, and brewing methods, offering a wide range of flavors and aromas to explore. Coffee also contains caffeine, a stimulant that can increase alertness and reduce fatigue, making it a go-to choice for professionals, students, and others to kickstart their day or boost their energy levels. There may even be health benefits to drinking coffee.

In order to make coffee more convenient and available, there has been a proliferation of simple, inexpensive coffee brewing machines that use disposable, single-serve coffee pods. A single serve coffee pod, commonly known as a coffee pod, capsule, or cartridge, is a pre-packaged portion of ground coffee beans enclosed in a filter housed within a plastic cup with a sealed, aluminum lid. In other embodiments, the lid can be formed from plastic or some other material. These pods are designed for single use and are compatible with specific coffee brewing systems, such as pod coffee and espresso makers Keurig™ and Nespresso™. Users simply insert a self-contained coffee pod into the coffee machine filled with water, press a button, and coffee is automatically dispensed into an awaiting cup. Thereby, consumers can enjoy a fresh, hot cup of coffee anytime at home, work, or travel.

One problem with these traditional coffee pods is that they are uniformly made the same way. They typically only have a single internal compartment for holding contents (e.g., coffee or tea). Because of their simplistic design, they are quite inexpensive to manufacture. However, the pods' simple construction severely restricts and limits the way by which the pods can be filled and used. Consequently, beverage choices are severely limited.

### SUMMARY OF THE INVENTION

Embodiments of the present invention pertain to a single use or reuseable beverage pod for use in a beverage brewing machine. The beverage pod has multiple compartments for containing different contents used to make the final beverage for human consumption. One compartment can be a solid, self-contained, non-porous, water-tight and perhaps air-tight compartment having a toroid base for containing a liquid, such as alcohol, syrup, dairy/cream, or flavoring. No matter how the beverage pod is rotationally oriented when inserted into the brewing machine, the toroid base ensures that a needle in a fixed location in the brewing machine, is guaranteed to pierced and release the contents contained therein. In one embodiment, the toroid base comprises a torus (e.g., circle torus, square torus, polygon torus, etc.). In another embodiment, the base can have a flat, round bottom. Another compartment can contain a dry content, such as ground coffee or tea. The dry and wet contents from these separate compartments are stored and kept apart in the beverage pod. The dry contents are kept dry in the dry compartment, while the liquid contents are kept liquid in the wet compartment. They are kept apart until the beverage pod is inserted into the beverage brewing machine. Once the brewing process is activated, the dry and wet contents from the multiple compartments are combined with water that flows through the beverage pod. The final brewed beverage (e.g., coffee or tea) that has a mixture of the liquid and dry contents released from the multiple compartments are disposed into an awaiting cup.

### BRIEF DESCRIPTION OF DRAWINGS

The accompanying drawings, which are incorporated in and form a part of this specification and in which like numerals depict like elements, illustrate embodiments of the present disclosure and, together with the detailed description, serve to explain the principles of the disclosure.

FIG. 1 shows one embodiment of the multiple compartment beverage pod of present invention.

FIG. 2 shows an embodiment of the multiple compartment beverage pod with an outer shell that has openings in its sides.

FIG. 3 shows an embodiment of a beverage (e.g., coffee or tea) brewing machine that accepts a beverage pod which has multiple compartments.

FIG. 4 shows an embodiment of a circle torus shaped container that is integrated inside a beverage pod.

FIG. 5A shows an embodiment of a beverage pod that has a cylindrical container integrated inside of it.

FIG. 5B shows an embodiment of a beverage pod that has an integrated cup shaped inner container with a toroid base and raised sides.

FIG. 5C shows an embodiment of a beverage pod 501 that has an integrated inner container 509 with a toroid base and a raised side with a partial circumference.

FIG. 5D shows a perspective view of a beverage pod having a separate inner container integrated therein.

FIG. 5E shows two embodiments of top views of a beverage pod that has two separate compartments. One compartment has a toroid base.

FIG. 5F shows a perspective view of a beverage pod that has a separate container inside of it.

### DETAILED DESCRIPTION

The present invention relates to a single serve beverage pod, capsule, cartridge, or container (hereinafter referred to collectively as a “pod”) that has multiple, separate compartments for containing different ingredients for making the beverage. The self-contained, imperforate beverage pod is hermetically sealed to contain multiple beverage ingredients, which can be either solid or liquid in form, stored in separate, non-permeable compartments. The ingredients are physically separated and kept apart by the multiple, separate compartments or chambers within the beverage pod. The beverage pod is designed to be pierced one or more times to allow liquid (e.g., hot water) to be injected into one or more of the compartments and for ingredients to be ejected from and flow out of the beverage pod into an awaiting cup.

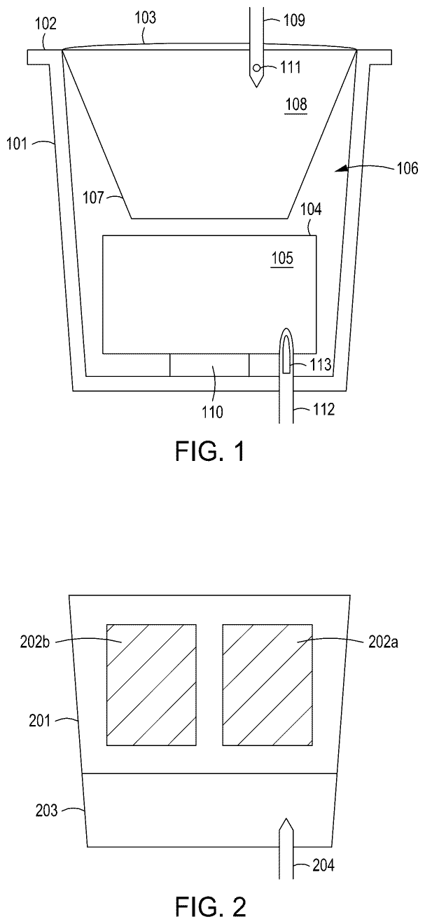

FIG. 1 shows one embodiment of the multiple compartment beverage pod of present invention. A perspective view of a beverage pod 101 is shown. The beverage pod 101 is comprised of a non-permeable (to water and air) outer shell 102 and a top cover 103, which seals the contents housed within the beverage pod 101. Residing within the outer shell 102 and top cover 103 is a solid, self-contained, non-porous, imperforated inner housing 104. Inner housing 104 can be plastic or some other rigid material that can be water tight and/or air tight. The contents contained within inner housing 104 will not leak out or evaporate out of the compartment. Inner housing 104 is set firmly on top of an offset base 110, such that it is raised above the floor of the plastic outer shell 102. This creates a circular gap between the floor of the plastic outer shell 102 and the bottom of the inner housing 104. It should be noted that in other embodiments, there is no gap between the inner housing 104 and the bottom or side of the outer shell 102. In other words, the bottom or side(s) of the outer shell can form part of the inner compartment. The inside of inner housing 104 forms a first compartment 105. This first compartment 105 can be filled with a liquid or solid beverage ingredient. For example, the first compartment 105 of inner housing 104 can be filled with alcohol, liquor, cocktail, mixed drink, garnishes, cocoa, flavorings, sweeteners, honey, cream, seasoning, etc. or a combination thereof. The volume of area outside of inner housing 104 but inside of the plastic outer shell 102 and top cover 103 forms a second compartment 106. A permeable filter 107 defines a third compartment 108, which can holds dry ingredients such as ground coffee, espresso coffee, tea leaves, powdered drink, etc.

In this embodiment, the beverage pod 101 is pierced by one or more needles. More particularly, when used in a brewing machine, the beverage pod 101 is pierced at its top, puncturing and passing through top cover 103, using a hollow needle 109. During brewing, the needle 109 injects liquid (e.g., hot or cold water) into the beverage pod 101 through an opening 111 in the needle 109. The liquid passes through and mixes with the ingredient 108 held by the permeable filter 107. The mixture then flows through compartment 106 and exits through another hollow needle 112. Hollow needle 112 pierces through the bottom of the plastic outer shell 102 and also through container 104. Hollow needle 112 has an opening 113 that extends through both compartment 105 and compartment 106. Thereby, the ingredients in compartments 105 and 106 flow or pass through the hollow needle 112 and exits one or more exit ports in a brewing chamber of the brewing machine (the brewing chamber is the portion of the brewing machine that receives the beverage pod 101) and drips into a pot, cup, or other receiving receptacle. This needle may be referred to as a nozzle.

An example of how this novel beverage pod 101 works is now described in detail. Ground coffee or espresso coffee is held in a filter 107. An alcoholic liquid, such as Irish Cream, whiskey, rum, peppermint schnapps, Kahlua, vodka, martini or any combination of liquors is contained in container 104. The user inserts this pre-packaged beverage pod 101 into the receptacle of a brewing machine designed specifically for receiving such beverage pods. Once the receptacle is closed, the top needle 109 pierces the top cover 103 and the bottom needle pierces the bottom of the outer shell 102 as well as the container 105. The user simply hits a button selecting the serving size. Water from the water receptacle filled by the user is immediately heated to the proper temperature to brew the coffee. Once heated, the water flows through the top needle 109 into the ground coffee within filter 107. The filter keeps the ground coffee from leaving the beverage pod. The brewed coffee flows through the filter 107 into compartment 106 and out from the beverage pod 101 through the hollow bottom needle 112 into an awaiting coffee cup. In addition, the alcohol within 105 also flows through the hollow bottom needle 112. One design allows for both the brewed coffee and the alcohol to flow through the bottom hollow needle 112 at the same time, so as to mix together.

In one embodiment, the top cover 103 and the shell 102 body may form an air-tight enclosure. In other words, the beverage pod 101 may be air-tight. In addition, the interior of the beverage pod 101 may be nitrogen flushed when the top cover 103 is applied to expel oxygen from the enclosure to prevent the degradation of the ingredients. In one example, the body portion of the beverage pod 101 has a truncated conical shape (e.g., shaped like a bucket or pail) or cylindrical in shape. The body portion of beverage pod 101 may include a ring portion which contacts the receptacle seating of the brewing machine that holds the beverage pod 101 in place. In other embodiments, there can be multiple top needles and/or multiple bottom needles. There can also be other paths and openings created, by which hot water can enter compartment 108.

FIG. 2 shows an embodiment of a multiple compartment beverage pod with an outer shell 202 that has openings in its sides. The openings are covered by filters or meshes (e.g., filter 202a and 202b). The inside of the outer shell 202 forms a first compartment that can contain dry ingredients, such as coffee, espresso, tea, etc. A second shell 203 can be fabricated by a solid non-permeable material. Inside of second shell 203 is a second compartment, which can contain a dry or liquid ingredient (e.g., alcohol, dairy product, flavorings, spices, sugar, honey, etc.). Hot water can enter the compartment formed by the outer shell 202 through the top via a hollow needle, mesh, or opening in the top. The hot water can also enter into the first compartment through the filter openings 202a and 202b. The mixture of the water and ingredients of the first compartment (e.g., brewed coffee) can flow out from the openings and filters 202a and 202b. Outer shell 203 can be pierced by a hollow needle 204 or an opening can be created by other means to release the contents or ingredients in the second compartment. The mixture of the water, ingredients from the first compartment, and the ingredients from the second compartment all flow into a cup, mug or other drinking container.

In one embodiment, because the pod is defined by a permeable filter, which acts as a housing for the pod, there is no need to puncture the bottom of the pod in order to extract the brewed liquid.

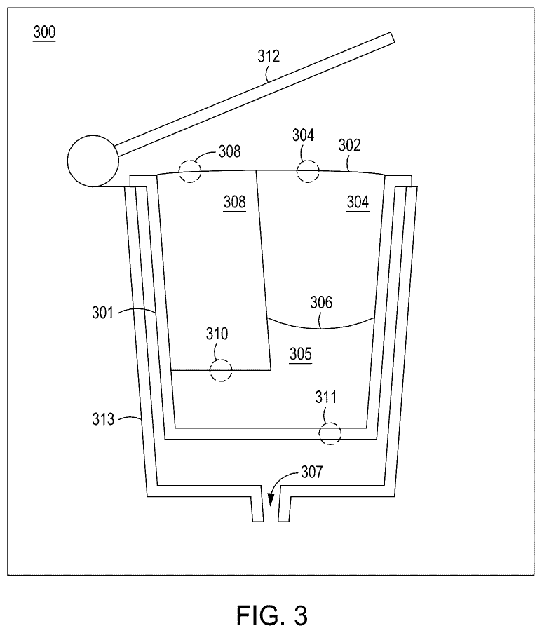

FIG. 3 shows an embodiment of a beverage (e.g., coffee or tea) brewing machine 300 that accepts a beverage pod 301 that has multiple compartments. Beverage pod 301 is a disposable, single-serve or reusable pod for brewing a beverage. It is inserted or laid in place onto a receptacle 313 in the brewing machine. Receptacle 313 is specially designed to accept and fit the beverage pod 301. A lid 312 can be used to open and close beverage pod receptacle 313. Closing lid 312 can activate the brewing process.

Beverage pod 301 is sealed with a top cover 302. Beverage pod 301 has multiple compartments that can contain dry and/or liquid contents therein. One or more of these compartments can be sealed off, isolated, self-contained, water-tight, and/or air-tight. For example, compartment 303 is defined by a solid, non-permeable, imperforated, water-tight plastic container. Consequently, it can contain a liquid (e.g., alcoholic liquor, dairy product, flavor extracts, etc.). In this embodiment, compartment 303 has a vertical orientation. It is more tall than wide. In other embodiments, compartment 303 is horizontal in orientation (e.g., more wide than tall) or a combination horizontal and vertical thereof. A separate compartment 304 can contain a dry ingredient, such as ground coffee, tea leaves, drink powders, etc. A filter, mesh, screen, or membrane 306 can be incorporated to retain the contents of compartment 304. An optional third compartment 305 can contain another type of dry or liquid ingredient (e.g., spices, thickening agent, flavor enhancers, coloring agents, aromatics, etc.). One or more openings can be created in the top, bottom, or sides of these compartments to release their respective contents. For example, compartment 303 can have one or more openings 308 created to vent its contents. Opening(s) 308 can also be created to inject a gas or liquid int compartment 303. One or more openings 310 can be created to release the contents of compartment 303. Similarly, one or more openings 309 can be created to vent or introduce liquids or gases into compartment 304. For example, hot water at the ideal brewing temperature can be pressurized and injected into compartment 304 to brew the coffee contained in compartment 304. Similarly, one or more openings 311 can be created to release the contents of the third compartment 305. For example, the brewed coffee from compartment 304 can flow and mix with cocoa, peppermint, nutmeg, cinnamon, sugar, diary powder, etc. held by compartment 305. One or more openings 311 in beverage pod 301 can be created to allow the contents of the various compartments 303-305, along with the hot/cold water inserted into the beverage pod to be released and flow into the receptacle 313 holding the beverage pod 301. These openings can be created by needles (hollow or solid), pull-outs, punch-outs, pins, lids, membranes (permeable, dissolvable, elastic), etc. One or more exit ports 307 enables the contents to flow out of the brewing machine 300 into an awaiting cup or beverage holder for the user to drink.

In other embodiments, additional compartments can be implemented in the beverage pod. A third, fourth, fifth, etc. compartment can be used to contain and keep separate any number of liquid or dry ingredients or combination thereof. These additional compartments can be porous or non-porous, rigid or flexible, water tight, and/or air tight.

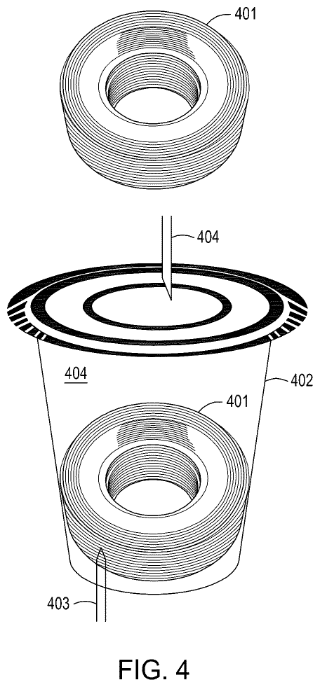

FIG. 4 shows an embodiment of a circle torus shaped container 401 that is integrated inside a beverage pod 402. The circle torus container 401 contains a liquid (e.g., alcohol, irish cream, Kalua, whiskey, vodka, cocktail, or combination) without leaking. As part of a brewing process, a hollow needle 404 pierces the top of beverage pod 402 and injects hot//cold water to brew the contents (e.g., coffee, tea, etc.) in compartment 404. In addition, a hollow needle 403 pierces the bottom of the beverage pod 402 and circle torus container 401. Because the bottom needle 403 is always in a fixed placement within the receptacle of the brewing machine, it is important that the container 401 has a toroid base. In one embodiment, the toroid base is comprised of a flat or flattish round bottom. A planar toroid base of integrated container 401 makes it so that no matter which radial or rotational orientation or direction the beverage pod 402 is inserted into the beverage machine, the bottom needle 403 is always guaranteed to pierce the bottom of container 401. In other words, as long as the user correctly inserts the beverage pod right-side-up, the flat circular bottom ensures that the bottom needle in the beverage machine will peirced the container 401. The brewed beverage of compartment 404 and the liquid from container 401 flow out of beverage pod 402 and the brewing machine and are combined to form a delicious drink for human consumption.

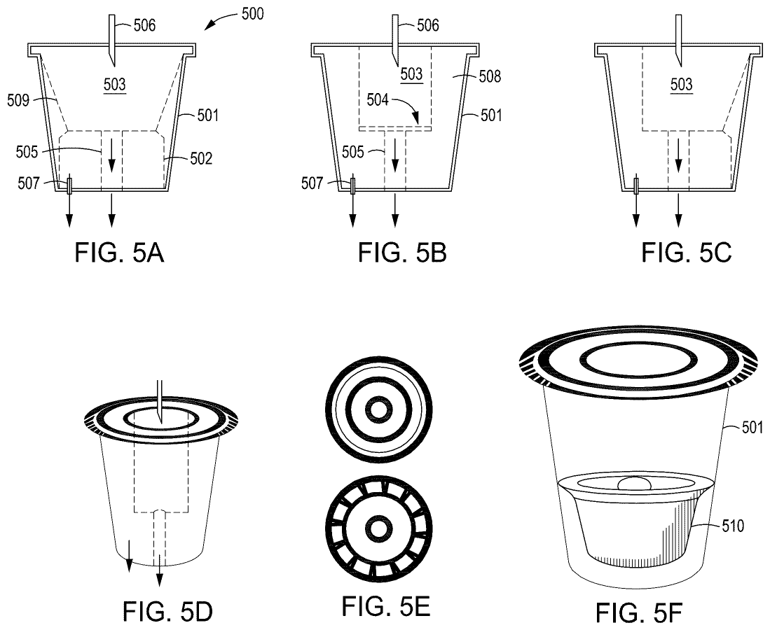

FIG. 5A shows an embodiment of a beverage pod 501 that has a cylindrical container 502 integrated inside of it. Cylindrical container 502 is made from a solid, non-permeable, water tight material (metallic, plastic, composite, etc.) so that it can hold a liquid indefinitely without leakage. Cylindrical container 502 has a toroid base, so that no matter what radial orientation beverage pod 501 is inserted into the beverage machine, the bottom hollow needle 507 is in position to pierce it. In other words, as long as the beverage pod 504 is inserted correctly into the beverage machine's receptacle, the fixed position bottom hollow needle 507 will pierce container 502, no matter the axis of rotation of the beverage pod 501 as inserted. Hot or cold water from the beverage machine flows through hollow needle 506 to brew the contents of container 503. An optional filter 504 filters the brewed beverage, which flows down through a open passageway 505 that extends down and bypasses cylindrical container 502. The brewed beverage flows out from beverage pod 501 through this open passageway 505. Basically, container 502 is in the general shape of a donut, with a “hole” in the middle. This default “hole” forms the passageway 505 through which the brewed beverage flows out from the beverage pod 501. In one embodiment, the bottom of container 502 is offset from the bottom of the beverage pod 501. A hollow needle 507 pierces the bottoms of the container 502 and beverage pod 501. The brewed beverage from container 503 and container 502 both flow through the hollow needle 507. In another embodiment, the bottom of beverage pod 501 forms the bottom of container 502. In other words, the bottom of beverage pod 501 is the same as the bottom of container 502. The brewed beverage of container 503 flows out from the beverage pod 501 through passageway 505. The contents of container 502 flows out from the beverage pod 501 through the bottom hollow needle 507.

FIG. 5B shows an embodiment of a beverage pod 501 that has an integrated cup shaped inner container 508 with a toroid shaped bottom or base and raised sides. The cup shaped inner container 502 is comprised of a solid, non-perforated, watertight material to hold liquid contents without leakage. The cup shaped inner container 502 by de facto forms a compartment 503 inside of beverage pod 501. It also de facto forms the central open passageway 505. Compartment 503 inside beverage pod 501 holds contents separated from the contents in container 502. Cold or hot water flows through hollow needle 505 to brew the contents of compartment 503, which is filtered by filter 504 and then flow out through central open passageway 505.

FIG. 5C shows an embodiment of a beverage pod 501 that has an integrated inner container 509 with a toroid/torus shaped base and a raised side with a partial circumference.

FIG. 5D shows a perspective view of a beverage pod having a separate inner container integrated therein. The inner container is solid, non-perforated, and watertight for holding a liquid ingredient. It can also hold a dry ingredient. It can be pressurized with a gas. Furthermore, a dynamically activated or passive venting mechanism can be fabricated as part of the inner container to counteract the negative pressure forces and aid in the release of the contents of the inner container (e.g., inner container 502, 508, and 509).

FIG. 5E shows two embodiments of top views of a beverage pod that has two separate compartments. One compartment has a toroid or torus shape in whole or in part. In other words, the compartment has one portion that is toroid or torus in shape.

FIG. 5F shows a perspective view of a beverage pod that has a separate container 510 inside of it. Container 510 fits inside of beverage pod 501. It is made of a solid watertight and airtight material. It has a full or partial toroid base, which can sit flush with the bottom of beverage pod 501; be the same as or part of the bottom material of beverage pod 501; or be offset from the bottom of beverage pod 501. Container 510 can be manufactured to be a whole piece as the beverage pod structure (minus the top cover). Container 510 can be manufactured as a separate piece which is filled and then inserted into beverage pod 501.

In one embodiment, the open passageway can be plugged. The plug can be part of a tray or other packaging material for holding one or more beverage pods. When the beverage pods are packaged for sale, the open passageways are plugged by the tray/package. The plugs provide an airtight seal to maintain freshness. When a beverage pod is removed for use, it is separated from the plug that is fixed in place with the tray, thereby unsealing the passageway.

The solid inner container residing inside a beverage pod to create two or more separate compartments inside of the beverage pod can be made up of many different shapes, volumes, dimensions, and sizes. For example, it can have a toroid (circular, square, polygonal, etc.) shape. It can have a torus (circular or non-circular) shape. It can have a cone, conical or truncated cone shape. It can have a hyperboloid shape. It can also have the following shapes: hexagonal pyramid, cuboid, cylinder, ring, prism, spherical, dodecahedron, octahedron, pyramid, buckyball, icosahedron, partial/half sphere, etc. The dimensions of the solid inner container can be custom designed for different volumes and sizes to accommodate different combinations of ingredients for different drink recipes. For example, one drink recipe may require more liquid ingredient(s), whereas another drink recipe may include less liquid ingredient(s) but more quantity of dry ingredient(s). Thereby, the volume of the inner container can be varied, depending on the specifics of the contents to be contained in the beverage pod as set forth by various drink recipes.

In one embodiment, the solid non-perforated watertight inner compartment can be manufactured a whole integrated piece of the entire beverage pod. In another embodiment, the solid non-perforated watertight inner compartment can be manufactured as a separate piece, which can be inserted into a commonly available existing beverage pod configuration.

In some embodiments, the single-serve container is a K-cup™ container. K-cup containers are described in greater detail in U.S. Pat. No. 5,840,189, the contents of which are hereby incorporated by reference herein.

In some embodiments, the single serve container may be a T Disc™ style container which is configured for use with a Tassimo™ brewer. T disc style containers are described in U.S. Pat. No. 7,231,869 which was filed on Jan. 23, 2004 and which is incorporated herein by reference.

In some embodiments, the single serve container may be a Nespresso™ container or Nespresso™ compatible container. In some embodiments, the single serve container may be a Nescafe™ Dolce Gusto™ style container.

The containers may take other forms apart from those listed above but the general mode of action is similar. The single serve pod serves to hold and protect the liquid and/or other ingredients internally, where the hot water is introduced to extract the actives and then ejected through the brewing machine head. The beverage pod can be made entirely from compostable and/or recyclable materials. In other embodiments, the beverage pod can be reused many times. A user can refill the compartment(s) and reuse the same beverage pods many times over to brew multiple cups of beverages. They can fill the compartments with various ingredients of their choice to brew drinks that suit their particular tastes.

Although illustrative embodiments of the invention have been described in detail herein with reference to the accompanying figures, it is to be understood that the invention is not limited to those precise embodiment. They are not intended to be exhaustive or to limit the invention to the precise forms disclosed. As such, many modifications and variations will be apparent.

What is claimed is:

1. A beverage pod for use in a brewing machine, the beverage pod comprising:
an outer housing;
a solid, imperforate, nonporous, watertight container having a toroid base inside the outer housing for holding a liquid;
a compartment within the outer housing but external to the container for holding a dry content, wherein the liquid in the container is kept separate from the dry content in the compartment before a brewing process begins and wherein when the brewing process begins, the liquid is released from the container and the dry content is brewed by water injected into the compartment by the brewing machine, portions of the liquid and brewed beverage flow out of the beverage pod to produce a beverage for human consumption.

2. The beverage pod of claim 1, wherein the liquid inside the container is comprised of an alcoholic consumable.

3. The beverage pod of claim 2, wherein the liquid inside the container is comprised of a diary product.

4. The beverage pod of claim 3, wherein the dry content in the compartment comprises ground coffee.

5. The beverage pod of claim 1, wherein a bottom of the outer housing and a bottom of the container are adapted to be pierced by the brewing machine to release the liquid.

6. The beverage pod of claim 1, wherein the compartment comprises a filter.

7. The beverage pod of claim 1, wherein the container comprises a cone shape.

8. The beverage pod of claim 1, wherein the container comprises a truncated cone shape.

9. The beverage pod of claim 1, wherein the container comprises a toroid shape.

10. The beverage pod of claim 1, wherein the container comprises a torus shape.

11. The beverage pod of claim 10, wherein the container comprises a circular torus shape.

12. The beverage pod of claim 1, wherein the container comprises a hyperboloid shape.

13. The beverage pod of claim 1, wherein the container comprises a cylindrical shape.

14. The beverage pod of claim 1, wherein the container forms a passageway that extends from the compartment to an opening of the outer housing.

15. The beverage pod of claim 1, wherein a portion of the bottom of the container also comprises a portion of a bottom of the outer housing.

16. The beverage pod of claim 1, wherein the container is offset by predetermined distance from a bottom of the outer housing.

17. The beverage pod of claim 1, wherein the container is a separate unit that is insertable into the outer housing.

18. A pod for use in a drink dispensing machine, comprising:
an outer shell;
a top cover over the outer shell, wherein the outer shell and top cover forms a first container;
a second container residing within the first container for storing a first drink ingredient, wherein the second container comprises a toroid portion;
a third container internal to and integrated within the first container comprised of the outer shell and top cover but external from the second container, wherein the third container can store a second drink ingredient and wherein the second container and the third container are adapted to release the first drink ingredient and the second drink ingredient when initiated by the drink dispenser machine to dispense a drink.

19. The pod of claim 18, wherein the second container is comprised of a solid watertight material that can store a liquid first ingredient without leakage, wherein the liquid first drink ingredient is kept separate from the second drink ingredient until a brewing process is initiated, once the brewing process is initiated, the liquid first ingredient and a liquid brewed from the second drink ingredient are released from the pod to produce the drink.

20. The pod of claim 19, wherein the second container forms a passageway through which a brewed liquid produced from the second drink ingredient flows.

21. The pod of claim 19, wherein the liquid ingredient comprises an alcoholic consumable.

22. The pod of claim 19, wherein the second container comprises a truncated cone shape.

23. The pod of claim 19, wherein the second container is situated in the approximate center of the outer shell.

24. A beverage pod for use in a beverage brewing machine, comprising:
a self-contained first compartment integrated with the beverage pod, wherein the self-contained first compartment can hold a first beverage ingredient;
a self-contained second compartment having a circular bottom portion integrated with the beverage pod, wherein the self-contained second compartment can hold a second beverage ingredient, wherein the first beverage ingredient and the second beverage ingredient are adapted to be mixed with a liquid injected into the beverage pod to produce a consumable beverage.

25. The beverage pod of claim 21, wherein the first compartment and the second compartment both reside inside the beverage pod and are external to each other.

26. The beverage pod of claim 25, wherein the first ingredient comprises a liquid and the first compartment holds the liquid without leakage until the liquid is intended to be dispensed from the first compartment.

27. The beverage pod of claim 26, wherein the first ingredient comprises an alcoholic liquid, the second ingredient comprises ground coffee and wherein the alcoholic liquid is released from the first compartment and is combined with a coffee drink brewed from the ground coffee held in the second compartment, the beverage pod dispensing an alcoholic coffee beverage.

28. The beverage pod of claim 24 comprises a reusable pod that is adapted to be opened, filled by a user, closed, and inserted into a brewing machine for brewing beverages multiple times.
